(19) United States
(12) Patent Application Publication
(10) Pub. No.: US 2020/0096302 A1
(43) Pub. Date: Mar. 26, 2020

(54) ORGANIC ANTI-RICOCHET BULLET AND METHOD FOR PRODUCING SAME

(71) Applicants: Maite FERNANDEZ, Santiago (CL); NITROMAX ARGENTINA S.A, Florida Oeste, Buenos Aires (AR)

(72) Inventor: Armando Francisco LEGUIZAMON, Buenos Aires (AR)

(73) Assignees: NITROMAX ARGENTINA S.A, Florida Oeste, Buenos Aires (AR); Maite Alejandra FERNÁNDEZ ROJAS, Santiago (CL)

(21) Appl. No.: 16/472,060

(22) PCT Filed: Dec. 13, 2017
(86) PCT No.: PCT/CL2017/050075

§ 371 Date: Jun. 20, 2019

(30) Foreign Application Priority Data
Dec. 20, 2016 (AR) P20160103926

(51) Int. Cl. F42B 12/74; F42B 33/00; F42B 30/02; C08L 101/16; C08K 3/26

(52) U.S. Cl. CPC F42B 12/74; F42B 33/001; C08K 2003/265; C08L 101/16; C08K 3/26; F42B 30/02

(57) ABSTRACT

A projectile manufactured with calcium carbonate. The projectile comprises a compound of calcium carbonate milled at more than 40 microns in the form of talc, with a sterilization at a temperature of more than 100 degrees Celsius. Optionally, it provides additives that only act as binders. The manufacture of the projectile may be made from calcium carbonate of organic origin. The animal bone is milled at more than 40 microns until obtaining a talc, and later it is sterilized at more than 100 degrees Celsius. Afterwards, it is mixed with water in a very low percentage, forming a paste, which is injected in moulds with a curing temperature as from 90 degrees Celsius, in a rapid manner to then pressed at high pressures. Thus, the merger of the mixture forming a solid projectile is attained.

This nonprovisional application is a continuation of International Application No. PCT/CL2017/050075, which was filed on Dec. 13, 2017, and which claims priority to Argentine Patent Application No. P20160103926, which was filed in Argentine on Dec. 20 2016, and which are both herein incorporated by reference.

### BACKGROUND OF THE INVENTION

### Field of the Invention

The present invention relates to

The present invention relates to an anti-ricochet organic bullet for civil use as well as to be used by public security forces, that can be utilized in different standard calibers of firearms, whether handguns or long guns.

### Description of the Background Art

There exists a great variety of projectiles: jacketed, semi-jacketed, of hollow point, of fragmentation and even of practice and non lethal, etc.

Bullet trajectory, specially that of handguns and away from the firing place, tends to be uncertain. In armed confrontations, specially between security forces and hostile civilians, where there exists or should exist an interest to neutralize the aggressor without killing him, the question is not to risk the lives of other innocent people. Police forces try to keep the “hot area” as much confined as possible. It is well known the amount of innocent civilians, dead or wounded by stray bullets or bullets that were not directed to them, either by ricochet or direct impact.

Also in armed confrontations in confined areas, there exists the possibility that a bullet fired by a member of a security force killed or wounded another member of the same team, even of killing or wounding himself caused by a ricochet.

A 9 mm caliber projectile may kill a person at a distance of more than 200 meters.

Lead is a metal very much used in projectiles: it is heavy, easy to mould and relatively economic. Saturnism, plumbism or lead poisoning is the poisoning caused by lead when it enters the human body. Lead is a heavy neurotoxic metal that when is present in the blood, it circulates around all the organism causing irreversible neurologic damages when it reaches the brain. Many people who were wounded by a bullet, which, by any reason, was not extracted, suffer from lead poisoning with the future consequences that same brings along.

In the previous state of the art there exists a plurality of documents that refer to patents of projectiles of low lethality or easy to be shelled.

French patent FR 2905169 of Bruno Thellier, dated Feb. 29, 2008. entitled a “non-lethal projectile that causes a fog” discloses a non-lethal projectile that produces fog, which is useful for hunting, that comprises compressed mixtures of biodegradable particles and fragments, which are disintegrated at the time of the impact, causing a fog. The core of the projectile is obtained by compressing a mixture of flour from cereals and/or legumes, with a compound of salt and/or sugar and elastic fibers. When the projectile impacts against a surface, it bursts forming a fog.

European patent EP 0953139 of Olin Corp., dated Nov. 3, 1999, entitled “projectile free of lead, formed by linkage of liquid phase” discloses a projectile which core is made of a first component of tungsten and/or its alloys, with a density superior to 9.8 g/cm3, a second component formed by metals having a merging temperature higher than 400° C. (zinc, iron, copper and their alloys), and a third component that works as a binder and is of metal.

U.S. Pat. No. 6,074,454 from Delta Frangible Ammunition, dated Jun. 13, 2000, entitled “fragile projectile free from lead and process for its manufacture” reveals a projectile with a higher fragility, made of powder of copper or of its alloys, which is compressed and later synthetized to obtain projectiles with the level of desired fragility. The projectile may provide additives to increase or reduce its fragility.

U.S. Pat. No. 4,455,942 of the Secretary of State of the Defense of the Government of the United Kingdom, dated Jun. 26, 1984, entitled “training ammunition” reveals a bullet with a standard cap, that contains a reduced propellant load, and a projectile with standard shape that comprises a core of rigid polyurethane foam and an outer coating not having the form of foam. It is manufactured for calibers of up to 10 mm.

EP patent 0626557 of Royal Ordnance dated Nov. 30, 1994, entitled “training projectile made of synthetized metal powder” reveals a projectile intended to training or practice that is broken at the time of the impact. The projectile is formed by a core of iron rough powder made by pressure and sintering, and the coating is a plastic. This projectile is manufactured for calibers of up to 12.7 mm.

US patent application 2006/0027124 of P. Sciafani, published on Feb. 9, 2006, entitled “non lethal ammunition with foam coating”, reveals a projectile that comprises a basis with a propellant, a plastic coating inserted to said basis, a foam coating, preferably expanded polystyrene, and in its interior, an elastomeric bag with sand and dyes.

U.S. Pat. No. 8,205,556 of Michael Keith and other, dated Jun. 26, 2012, entitled “less lethal projectile of precision”, reveals a projectile that comprises a hollow body filled with a high density filling, such as metal, and where the coating is a fabric fixed to the basis of the bullet by means of an O ring.

### SUMMARY OF THE INVENTION

It is therefore an object of the present invention to provide a projectile that has a great stopping power at a distance not higher than 50 meters and that be relatively harmless at greater distances.

Another objective of the present invention is to provide a projectile that gets disintegrated once it did the first impact, providing the neutralization of the danger.

Another objective of the present invention is to provide a projectile that does not rebound when impacting laterally against any surface, that is: that has no ricochet angle.

Another objective of the present invention is to provide a projectile that does not cause an unnecessary damage to the opponent according to the Geneva Convention.

Another objective of the present invention is to provide a lethal projectile at short range.

Another objective of the present invention is a projectile that, being lodged in a living being, be naturally absorbed by himself and that it does not remain lodged in said body, jeopardizing the organism in the long run.

Another objective of the present invention is to provide a projectile easy to manufacture and that it is economic.

Another objective of the present invention is to provide a projectile adaptable to the measures of standard cartridges.

Another objective of the present invention is to provide a projectile that does not perforate Blindex-type glass so as not to cause damage in case of missing the target.

Another objective of the present invention is to provide projectiles of different colors to identity which arms shot them, that is: different colors may be had so as to identify the security forces involved in a shooting.

Another objective of the present invention is to provide a projectile that may be shot inside public places of maximum attendance since it does not have the ability of passing through more than one human body.

Another objective of the present invention is to provide a projectile that may be shot inside airplanes with no possibility of perforating fuselage.

### DETAILED DESCRIPTION

The present invention reveals a projectile made of calcium carbonate, which is a substance of great abundance in nature. Calcium carbonate is part of rocks, shells and skeletons of living beings, etc.

The projectile comprises a compound of calcium carbonate milled at more than 40 microns in the form of talc, with a sterilization at a temperature of more than 100 degrees Celsius.

Optionally, it provides additives that only act as binders.

The manufacture of the projectile may be made from calcium carbonate of organic origin. The animal bone is milled at more than 40 microns until obtaining a talc, and later it is sterilized at more than 100 degrees Celsius. Afterwards, it is mixed with water in a very low percentage, forming a paste, which is injected in moulds with a curing temperature as from 90 degrees Celsius, in a rapid manner to then press it at high pressures. Pressures vary according to the hardness of the projectile but may vary from 50 Kg/cm² to 1.000 Kg/cm². Thus, the merger of the mixture forming a solid projectile is attained.

Additionally, other compounds may be added to the paste, which are not harmful to living beings. Carbonic acid, phenic acid, phenylic acid, phenyl hydroxide, phenyl hydrate, oxybenzene, or hydrobenzene may be mixed; these are not only binders but also they are antibacterian, preventing the proliferation of bacteriae in projectiles.

Furthermore, the main component that is the calcium carbonate may be mixed with existing resins and materials that act as binder, preferably those which are not toxic for the human body.

Resins render a higher hardness in the moulding process of projectiles.

Natural latex prevents, in case of non jacketed or semi-jacketed ammunition, the entrance of bacteriae in the pores of the projectile.

Also, dyes or anilines may be added to render a color to each projectile with the intention of identifying the ammunition used by different forces. For example: UN peacekeeping (Blue Helmets): white; Argentine Federal Police: black, Buenos Aires Metropolitan Police: green; Argentine National Gendarmerie: red; etc.

In case of requiring jacketed proyectiles, the casing of the projectile is filled with the chosen compound by means of injection within the brass jackets.

In case of projectiles intended to very confined areas or airplanes, the jacket may be of latex and the projectile core of a proportion of components of high porosity and low molecular weight. This combination causes the projectile to have a lethal reach of no more than 25 meters.

The invention being thus described, it will be obvious that the same may be varied in many ways. Such variations are not to be regarded as a departure from the spirit and scope of the invention, and all such modifications as would be obvious to one skilled in the art are to be included within the scope of the following claims:

What is claimed is:

1. An anti-ricochet bullet, wherein it is comprised of calcium carbonate, and optionally of additives.

2. The anti-ricochet bullet of claim 1, wherein same gets disintegrated at the first impact.

3. The anti-ricochet bullet of claim 1, wherein it does not rebound when impacting laterally on a surface.

4. The anti-ricochet bullet of claim 1, wherein it is naturally absorbed by the organism where it is lodged.

5. The anti-ricochet bullet of claim 1, wherein it provides different colors.

6. The anti-ricochet bullet of claim 1, wherein the optional additives are carbonic acid, phenic acid, phenylic acid, phenyl hydroxide, phenyl hydrate, oxybenzene, hydrobenzene, resins, latex, dyes, anilines and/or mixtures thereof.

7. A process to manufacture the anti-ricochet bullet of claim 1, wherein it comprises the steps of:
Milling the calcium carbonate at more than 40 microns until forming a talc;
Sterilizing at more than 100° C.;
Mixing with a very low proportion of water forming a paste;
Injecting the paste in moulds with a curing temperature of more than 90° C.;
Pressing the paste inside the moulds according to the required hardness of the bullet.

8. The process of claim 7, wherein the step of pressing the paste is made at pressures between 50 and 1,000 Kg/cm².
